(19) United States
(12) Patent Application Publication
(10) Pub. No.: US 2010/0097226 A1
(43) Pub. Date: Apr. 22, 2010

(54) OCCUPANCY SENSING WITH IMAGE AND SUPPLEMENTAL SENSING

(75) Inventor: Kevin Parsons, Wilsonville, OR (US)

Correspondence Address: Marger Johnson & McCollom PC - Leviton, 210 SW Morrison, Suite 400, Portland, OR, 97204, US

(73) Assignee: LEVITON MANUFACTURING CO., INC., Little Neck, NY (US)

(21) Appl. No.: 12/256,167

(22) Filed: Oct. 22, 2008

(51) Int. Cl. G08B 23/00

(52) U.S. Cl. 340/573.1

(57) ABSTRACT

An occupancy sensing system monitors a space with an image sensor and a supplemental sensor. The occupancy condition of the space is determined in response to information from both the image sensor and the supplemental sensor. An electrical load for the space is controlled in response to the occupancy condition.

### BACKGROUND

Occupancy sensors are used to monitor the presence of human occupants in indoor and outdoor spaces. Occupancy sensors conserve energy by automatically turning off lighting and other electrical loads when the space is unoccupied. Occupancy sensors also perform a convenience function by automatically turning on lighting and other loads when an occupant enters the space.

Numerous sensing technologies have been used with occupancy sensors. One example is passive infrared (PIR) sensing which operates on the principle that the thermal energy of warm objects causes them to emit infrared radiation. The infrared radiation is sensed by a photocell which converts the radiation to electric signals for further processing. Another example of occupancy sensing technology is ultrasonic sensing. In an ultrasound system, the monitored space is flooded with ultrasonic waves that are constantly emitted by an ultrasound driver. An ultrasound sensor detects waves that are reflected by an occupant and/or other objects in the monitored space. By comparing the emitted and reflected waves, an ultrasonic system can determine whether an object is moving. Moving objects are assumed to be occupants.

Some occupancy sensors use a combination of sensing technologies. One widely used combination is PIR and ultrasound. PIR is generally more accurate for detecting large motion such as a person walking into a room in a path that is directly within the line-of-sight of the occupancy sensor. Ultrasound systems tend to be more sensitive for detecting small motion, such as a person working at a desk, and motion that is hidden from the line-of-sight of the occupancy sensor, such as behind partitions in an office or restroom. The added sensitivity, however, may cause false occupied readings. Therefore, an occupancy sensor may initially use only PIR sensing to determine that the monitored space has become occupied. Once the space is initially determined to be occupied, an occupied reading from either PIR or ultrasound may be used to determine that the space continues to be occupied. A countdown timer is typically used to keep the lights on only for a predetermined period of time unless occupancy is sensed again during the countdown time. The countdown timer is reset to a predetermined value (typically 10-30 minutes) when occupancy is initially sensed and the lights are turned on. The timer then continues to decrement toward zero. Each occupied reading from either PIR or ultrasound causes the timer to reset to the maximum value. If the timer decrements all the way to zero before another occupancy event is detected, the lights are turned off, and the sensor returns to the PIR only sensing mode.

Another known combination is PIR combined with audio sensing. PIR sensing is used to detect the motion of an occupant entering a room, then audio sensing is used to detect sounds that indicate continued occupancy.

Despite many years of development and attempts to perfect various sensing technologies and combinations of technologies, occupancy sensors continue to be plagued by false determinations of occupied and unoccupied conditions.

### BRIEF DESCRIPTION OF THE DRAWINGS

FIG. 1 illustrates an embodiment of an occupancy sensing system according to some inventive principles of this patent disclosure.

FIG. 2 illustrates an embodiment of an occupancy sensing method according to some inventive principles of this patent disclosure.

FIG. 3 illustrates another embodiment of an occupancy sensing system according to some inventive principles of this patent disclosure.

FIG. 4 illustrates a monitored space to illustrate an example installation of the occupancy sensing system of FIG. 3.

FIG. 5 illustrates another embodiment of an occupancy sensing system according to some inventive principles of this patent disclosure.

FIG. 6 illustrates a monitored space to illustrate an example installation of the occupancy sensing system of FIG. 5.

### DETAILED DESCRIPTION

Advances in manufacturing and integration technology have expanded the range of sensor types that can realistically be integrated into a small, inexpensive multi-technology occupancy sensor. One sensor type that may now be incorporated is an image sensor, for example, a charge coupled device (CCD) sensor. Image sensor may respond to visible (or near-visible, e.g., infrared or ultraviolet) light. Their resolution is greater than that of older PIR systems, which merely produce a signal when some object at a different temperature than ambient moves somewhere within the sensor's field of view. The addition of higher-resolution image acquisition capability requires new operational logic to make good use of the new information.

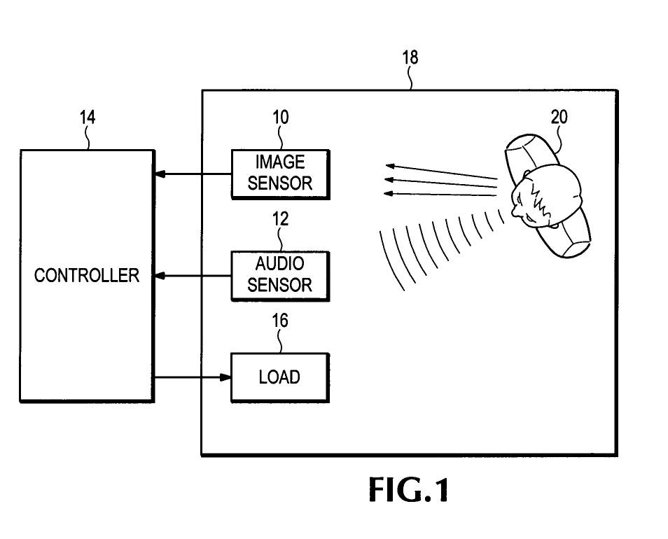

FIG. 1 illustrates an embodiment of an occupancy sensing system according to some inventive principles of this patent disclosure. The embodiment of FIG. 1 includes an image sensor 10, a supplemental sensor 12 which, in this example, includes an audio sensor, and a controller 14 which controls an electrical load 16 for a monitored space 18 in response to an occupancy determination based on information from the image and audio sensors which are arranged to sense any occupants 20 within the space.

The components shown in the embodiment of FIG. 1 may be realized in a wide range of implementation details. For example, in some embodiments, the image sensor 10 may be highly integrated and include one or more complete video cameras with image processing hardware and/or software to produce a simple binary output signal that indicates whether an occupant is sensed in the space. In other embodiments, the image sensor may include one or more fundamental image sensing devices such as a charge coupled device (CCD) or an array of photo sensors that produce raw image signals requiring further processing to be used in the occupancy determination. In some embodiments, the image sensor may only respond to visible light, while in other embodiments, the image sensor may respond to light at infrared and/or ultraviolet wavelengths as may be suitable for the particular occupancy sensing environment. The image sensor may further include hardware and/or software to cause it to respond differently to light in different portions of the spectrum.

As with the image sensor, the supplemental sensor 12 may be implemented with any level of complexity and functionality. In some embodiments, the supplemental sensor may include an audio sensor as shown in FIG. 1. The audio sensor may include one or more complete audio sensing systems that produce high level output signals, while in other embodiments, the audio sensor may include one or more fundamental audio sensing elements such as a transducer that requires amplification and/or other processing to be used in the occupancy determination. The audio sensor may respond to sound at audible frequencies, or other frequencies or combinations of frequencies as may be suitable for the particular occupancy sensing environment.

In other embodiments, the supplemental sensor may include a passive or an active ultrasound sensor, PIR, or any other sensor based on a technology that does not monitor a visual characteristic of the space. In yet other embodiments, the image sensor 10 may include a first type of image sensor, while the supplemental sensor 12 may include a second type of image sensor. For example, the first image sensor may include an image sensor that operates on visible light, while the second image sensor may be based on infrared or ultrasound imaging technology.

The electrical load 16 may include lighting loads, heaters, air conditioners, ceiling fans, exhaust fans, and any other loads or combinations of loads that may act on the space in response to the occupancy condition of the space.

The controller 14 may be implemented in hardware, software or any combination thereof. The complexity and functionality of the controller 14 may depend on the relative complexity and functionality of the other components of the system. For example, in a system with highly integrated image and audio sensors, the controller may only include relatively simple logic to control the load 16 in response to binary signals from the sensors. In other embodiments with relatively low level sensors, the controller may include extensive hardware and/or software to process the signals from the image and audio sensors. The controller 14 may also include various types of hardware and/or software to control the load 16. For example, in some embodiments, the controller may include complete load switching circuitry such as relays, transistors, thyristors, etc., to provide on/off, dimming, or other forms of load control. In other embodiments, the controller may only provide a simple digital or analog output control signal to enable other apparatus to control power to the load. The controller may include one or more microprocessors or microcontrollers, discrete logic, analog circuitry, or any other suitable apparatus and/or software to implement any of the automatic sensing and/or control schemes according to the inventive principles of this patent disclosure.

The connections between the controller 14, the image sensor 10, the audio sensor 12 and/or the load 16 may be in any suitable form. Hardwired connections may include screw or spring terminals, pigtail leads, printed circuit (PC) board traces, fiber-optic cable, etc. Wireless connections may include any signaling media such as radio frequency (RF), infrared (IR), optical, etc.

The components shown in FIG. 1 may be arranged in any physical relation to the space 18 and to each other. Any or all of the components may be located in, near, or remote from the space. For example, electrical lighting loads may typically be located in or just above the space, whereas an exhaust fan or air conditioning (A/C) load may be located remotely from the space. The controller 14, image sensor 10 and audio sensor 12 may be arranged in any combination of common or separate locations and in common or separate enclosures, if any. For example, in one embodiment, the controller, image sensor and audio sensor may be located in a common wall switch enclosure that includes power control circuitry for controlling the load. In another embodiment, the image and audio sensors may be located in one or more separate enclosures that are mounted remotely from the controller. In yet another embodiment, the controller, image sensor, and audio sensor may be located in a ceiling mount or wall/corner mount enclosure that sends low-voltage control signals to a relay cabinet or other apparatus for controlling the power to the load.

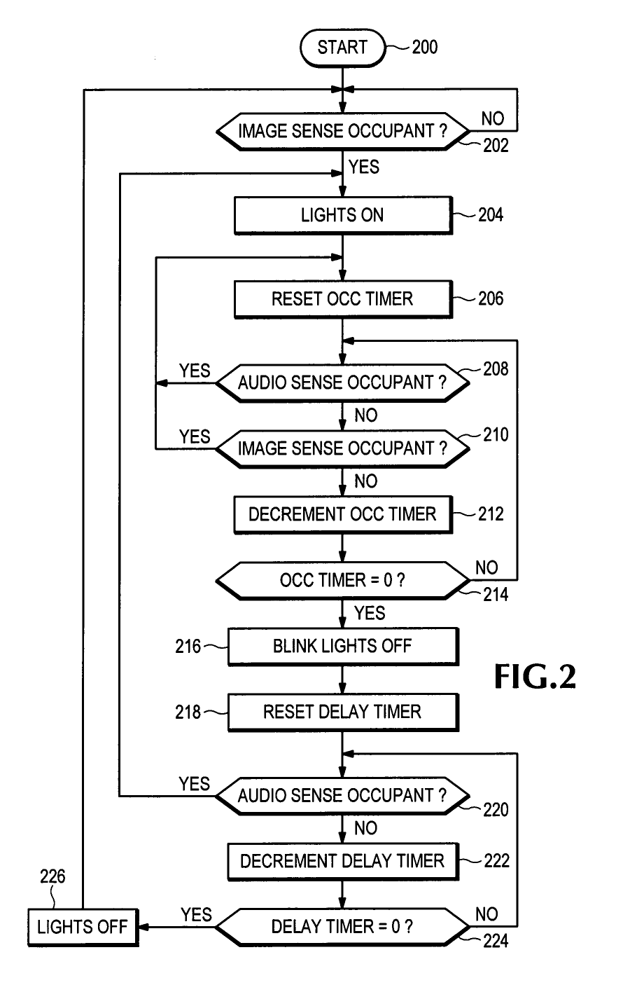

FIG. 2 illustrates an example embodiment of an occupancy sensing method according to the inventive principles of this patent disclosure. This embodiment is described in the context of a system in which the image sensor is implemented with a video camera and the system is configured to control a lighting load in the monitored space. The inventive principles, however, are not limited to these details.

The method begins at 200 where the monitored space is assumed to be unoccupied, and the lights are off. At 202, the image sensing process is continuously used to determine if an occupant has entered the room. The process loops at 202 until an occupant is determined to have entered. The lights are then turned on at 204 and an occupancy timer is reset at 206. A typical reset value for an occupancy timer may be 10-30 minutes, but any suitable time may be used. At 208, the audio sensing operation is used to determine if an occupant is still in the room. Each time an occupant is determined to be present by the audio sensing operation, the occupancy timer is reset at 206, and the audio sensing operation is repeated at 208. If the audio sensing operation does not sense an occupant, the image sensor is checked again for motion at 210.

If neither sensing operation detects an occupant, the occupancy timer is decremented at 212, and checked at 214 to determine if the occupancy time has expired. If not, the process returns to 208 where the audio sensor is checked again. If the occupancy time has expired, the lights are turned off momentarily (blinked) as a warning at 216, and a delay timer is reset at 218. This is a tentative unoccupied state. A typical reset value for a delay timer may be 5-15 seconds, but any suitable time may be used. At 220, the audio sensing operation is used to determine if an occupant is present, as may be apparent, for example, from an undetected occupant shouting out in response to the lights turning off. If an occupant is determined to be present through the audio sensing operation, the lights are turned back on at 204, and normal occupied operation is resumed. If no occupant is sensed at 220, the delay timer is decremented at 222 and checked for expiration at 224. As long as no occupant is sensed, the method continues to loop through 220, 222 and 224 until the delay timer expires, at which point the unoccupied state is confirmed, the lights are turned off at 226, and process returns to 202 and begins again.

Many variations to the embodiment of FIG. 2 are possible according to the inventive principles of this patent disclosure. For example, in another embodiment, rather than blinking the lights, the lights may be turned off at 216 for the duration of the delay period or until an occupant is determined to be present through the audio sensing operation at 220. In such an embodiment, the lights would already be off, and thus, 226 is not necessary. In yet other embodiments, an audible signal such as a beep sound may be used as a warning to signal the beginning of the delay period.

The interoperation of an image sensing technology with a supplemental sensing technology according to the inventive principles of this patent disclosure enables the implementation of occupancy sensing systems in which each of the sensing technologies may operate differently than it would operate as an individual sensor or in prior art combinations of sensors. For example, prior art audio sensors are typically designed to be sensitive to a wide range of audio frequencies from all directions regardless of whether the audio sensor is a stand-alone device or combined with a PIR sensor. Other than an angular field of view, a PIR sensor has no ability to discern the location or the direction of a moving occupant within the monitored space. Thus, an audio sensor used in combination with a PIR sensor is designed to detect audible sounds relatively indiscriminately. Combined with an image sensor, however, an audio sensor according to the inventive principles of this patent disclosure may be implemented in a more refined manner to provide a more accurate occupancy determination. For example, an image sensor may be set up to provide accurate motion sensing in a defined region of interest within its field of view, which may include an open portion of a room, but exclude visible portions of hallways and areas behind partitions. The audio sensor may then be optimized in terms of directionality, frequency sensitivity, threshold levels etc., to sense sounds primarily from behind the partitions. Alternatively, the audio sensor may be optimized to sense specific echoes or audio profiles caused by certain portions of the room which act as waveguides, resonators, etc. Thus, the interoperation of image sensing technology and audio sensing technology according to the inventive principles of this patent disclosure may provide synergistic results in which each technology can contribute to a higher level of overall performance.

In some embodiments, a level of directionality may be imparted to the audio sensing operation. In one example, the audio sensor may include shutters, waveguides, or other physical structures that guide sound to the sensing element from certain directions or areas. Such structures may be arranged to complement or augment the coverage provided by the image sensor, i.e., by selectively sensing sounds in a portion of the monitored space that is not within the field of view or defined area of interest of the image sensor. Alternatively, the structures may be arranged to only sense sounds that are within, or in an area overlapping with, the coverage area provided by the image sensor.

As another example, the audio sensing element itself may be arranged to be only sensitive or more sensitive, to sound from certain directions or areas, as by mounting a microphone or other audio transducer to the occupancy sensor on a swivel or other moveable mount. Alternatively, the entire occupancy sensor itself may be constructed in such a manner as to enable it to point in a designated direction for audio directionality.

As a further example, the audio sensor may be implemented with an array of microphones or other transducers which, through signal processing of phase delay or other techniques, may determine the direction from which a sound is received, and therefore, respond selectively to sounds from certain directions or areas. Such an array may be mounted on a single occupancy sensor housing, or arranged with sensors mounted remotely from a main occupancy sensor housing.

Any of the above-mentioned techniques for imparting directionality to the audio sensing function may be coordinated with the image sensing function to complement or augment the coverage provided by the image sensor, and/or to avoid known or unknown sources of background noise such as an exhaust fan or appliances or other equipment in the monitored space, and prevent false determinations of occupancy conditions.

In some embodiments, the audio sensing function may be selective based on the characteristics of the sound received by the audio sensor. For example, the audio sensor and/or controller may include signal processing hardware and/or software to implement frequency filtering to filter out sound at frequencies that are unlikely to be caused by occupants. For example the audio sensing process may be made less sensitive to the frequency profile of ventilators or other air-handling equipment. In contrast, in areas where occupants are likely to make clanking noises, the audio sensing operation can be more selective to the high frequency sound or ultrasound characteristic of hard objects such as metal striking together.

As another example, speech recognition software may be utilized to determine the presence of human occupants, since other sources of noise are unlikely to randomly generate sounds that are recognizable as human speech.

In a further example, the audio sensing operation may include functionality to selectively respond to sounds that have the characteristics of echoes or other reflections. For example, if an audio sensor receives two distinct sounds having the same or similar waveform during a very short time frame, it may indicate that the sound came from within the confines of a partition or other echo-inducing structure that may be outside the field of view of the image sensor. The occupancy sensor may provide enhanced responsiveness to such an echo-like sound, which may provide a complementary occupancy sensing technique to the image sensor.

In another example, the audio sensing operation may include functionality to selectively respond to sounds that exhibit a step function in terms of sound level, frequency, or the like. For example, a sound that starts abruptly and has a uniform and continuous volume and/or frequency profile may be more likely to have been generated by an air conditioner turning on than by an occupant. In contrast, shorter, undulating sounds in the form of random pulses are more likely caused by actual occupants.

Any of the above-mentioned techniques for imparting selectivity to the audio sensing function based on the nature of the sensed sound may be coordinated with the image sensing function to complement or augment the coverage provided by the image sensor, and/or to avoid known or unknown sources of background noise and prevent false determinations of occupancy conditions. For example, characteristic sounds from certain types of occupant activity may be more prevalent in areas of the monitored space that are outside of the field of view of the image sensor. The inventive principles enable the audio sensing function to be adapted or optimized for selective responsiveness to the sound characteristics of those certain types of activities. This may enable more accurate overall occupancy sensing than may be possible if the image sensing and audio sensing were not coordinated.

In some embodiments, the audio sensing operation may include training functionality that reduces the sensitively of the system to non-occupant generated sounds and/or increases the sensitivity to occupant generated sounds. For example, the audio sensing operation may measure a baseline of ambient noise during a set-up or install operation, or periodically or continuously during normal operation, and only determine occupancy if the sensed sound level is higher than the baseline level. During a set-up or install operation, the baseline determination may rely on any ambient sounds, or natural or artificial sources of sound may be purposely introduced to train the audio sensing operation to ignore these baseline sound sources. For example, all known sources of background noise such as exhaust fans, air handler equipment, refrigeration units, computers, etc., may be turned on simultaneously or sequentially during a training operation to enable the audio sensing operation to learn to ignore these noise sources. Alternatively, artificial sources of specific sounds may be introduced into the monitored space through speakers or other apparatus during a training operation to enable the audio sensing operation to learn to ignore certain sounds such as automobile horns, but turn lights on in response to the sound of breaking glass. Training may be specific to time-of-day, day-of-week, etc. to provide enhanced ability to ignore or react to different audible sounds that may typically be encountered at different times. For example, the audio sensing operation may be trained to be less sensitive to ambient noise at times such as a shift ending at a place of business, flights arriving at airports, rush-hour traffic at certain times of day, etc.

The audio sensing operation may be coordinated with the image sensing operation so that certain sounds are ignored or responded to in a first manner under certain occupancy conditions determined by the image sensing operation, but ignored or responded to in a second manner during other occupancy conditions determined by the image sensing operation.

In some embodiments, the image sensor may operate on a pixel count principle where the grayscale or other numerical values associated with each pixel in an image device are totaled from time-to-time and stored as a pixel count for comparison to previous and or future values. A certain amount of change in the pixel count indicates motion and thus an occupied condition. In other embodiments, image recognition algorithms may be used to detect specific types of motion, location of occupants, direction of motion, etc. in the image sensor's field of view to implement various occupancy sensing schemes. For example, trip lines may be defined during a set-up or install operation to enable the image sensing operation to keep a running total of occupants based on the number of occupants that have crossed the trip line, with or without consideration of direction in which they have crossed the trip line. As another example, one or more regions of interest may be defined within the monitored space, e.g., by drawing the region on a screen showing a simulated or real-time representation of the space, or through other techniques such as those based on recording the motion of a person.

In some embodiments, the image sensing operation may include training functionality to reduce the sensitively of the system to non-occupant generated images and/or increase the sensitivity to occupant generated images. For example, if area-of-interest functionality is not available, a training operation may enable the image sensing operation to learn to ignore images such as people walking through a visible hallway, or automobile or pedestrian traffic that is visible through a window in the field of view.

In some embodiments, the image sensing operation may be adapted or optimized to coordinate with the capabilities of the audio sensing operation. For example, if the audio sensor may be trained or inherently capable of responding to the sound of a door opening, then the image sensor may be arranged in a location that is not in view of the door. This may enable the image sensor to be placed in a location that is more favorable to occupancy sensing in another part of the space. In such an example, the audio sensor may be used to make the initial determination of occupancy condition of the room.

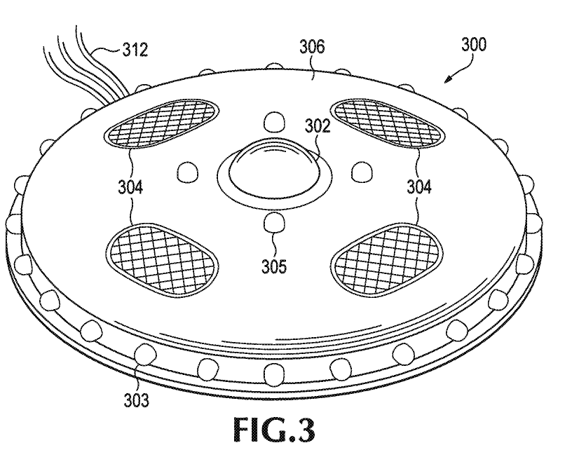

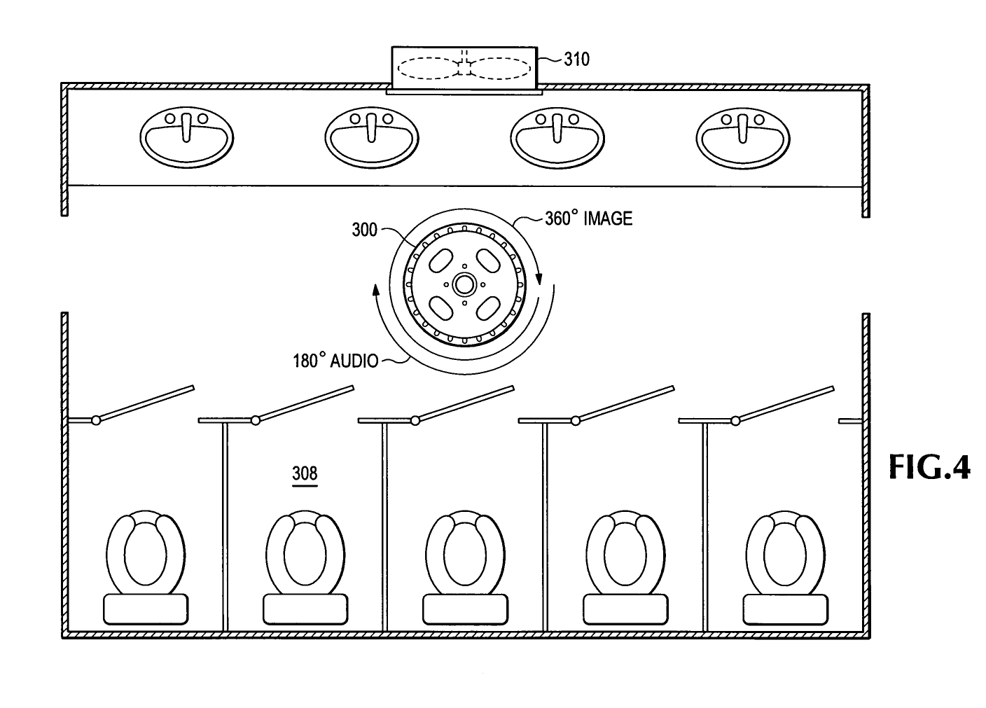

FIG. 3 illustrates an embodiment of an occupancy sensor according to some of the inventive principles of this patent disclosure. In the embodiment of FIG. 3, the occupancy sensor 300 includes an image sensor 302 and one or more directional audio sensors 304 mounted on a chassis and visible through a cover 306 attached to the chassis. This embodiment is intended for ceiling mounting with the image sensor 302 oriented downward to provide up to a 360 degree field of view from the mounting location. All or some of the audio sensors 304, which sense sounds primarily from the direction in which they are facing, may be used depending on the specific installation. For example, when installed in a room having partitions 308 along one side as shown in FIG. 4, the occupancy sensor 306 may be centrally located to provide a 360 degree field of view of the entire room except for all or a portion of the space within the partitions. All of the audio sensors except the one oriented toward the partitions may be disabled so that only sounds from the direction of the partition are used by the audio sensing operation. This may provide improved sensing of occupants within the partitions, while eliminating false determinations of occupancy based on noise from sources elsewhere within the room. For example, an exhaust fan 310 may be located opposite the partitions as shown in FIG. 4. Since the audio sensors that are oriented more in the direction of the exhaust fan are disabled in this installation, noise from the exhaust fan 310 is less likely to cause a false occupancy determination.

Alternatively, one or more omni-directional audio sensors may be utilized, in which case the orientation of the occupancy sensor may not matter for purposes of the audio sensing operation. More than one image sensor may also be used to provide improved image sensing operation. In some embodiments, the audio sensor or sensors may be mounted on a rotating ring built into the chassis to enable the installer to change the directionality of the audio sensing operation without having to move or change the location or orientation of the occupancy sensor, and without having to selectively enable or disable one or more of the audio sensors. Various controls for adjusting the operation of the sensor maybe located on the back of the occupancy sensor, or inside the chassis in a location that can be accessed by removing the cover 306 or an access door or panel in the cover. These controls may be implemented to control any of the operational characteristics of the occupancy sensor as described above.

In the example embodiment of FIG. 3, the occupancy sensor does not include power switching or control circuitry, but instead sends low-voltage control signals over leads 312 to a relay cabinet or other apparatus for controlling the power to the electrical load. Alternatively, some or all of the power switching circuitry may be included in the sensor.

The embodiment of FIG. 3 also includes illuminators 303 and 305 to provide supplemental illumination for the image sensor 302. Illuminators 303 are arranged around the periphery of the occupancy sensor 300 to project illumination generally outward in all directions. Illuminators 305 are arranged closer to the image sensor 302 to project illumination generally downward from the occupancy sensor when it is mounted on a ceiling. The illuminators may provide illumination at one or more wavelengths that the image sensor 302 is sensitive to, e.g., infrared light for an infrared image sensor, visible light for a video camera that operates on visible light, or broadband light for an image sensor that employs more than one type of sensing technology.

In some embodiments, some or all of the illuminators may provide constant illumination, while in other embodiments, they may be controlled by a controller to provide illumination at selective times. For example, the lights in a conference room may be off or dimmed during a video or slide projector presentation. In this situation, the controller may periodically turn on some or all of the illuminators momentarily to assist the image sensor in scanning for occupants. The controller may also selectively control which illuminators are energized. For example, a monitored space may have adequate illumination in all but one dark corner. In this situation, the controller may then only enable the illuminators oriented in the direction of the dark portion of the space.

The illuminators shown in FIG. 3 project from the body of the occupancy sensor, but in other embodiments, they may be recessed and/or covered by one or more lenses made from material that is transparent to the particular wavelengths at which they operate. Such lenses may be arranged to focus the illumination at strategic places, or they may be omni-directional, i.e., provide no directionality.

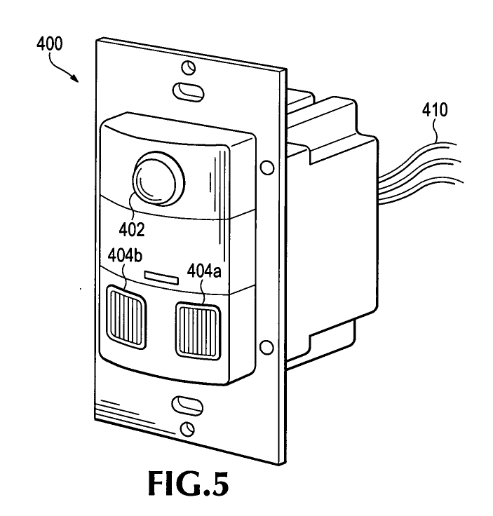

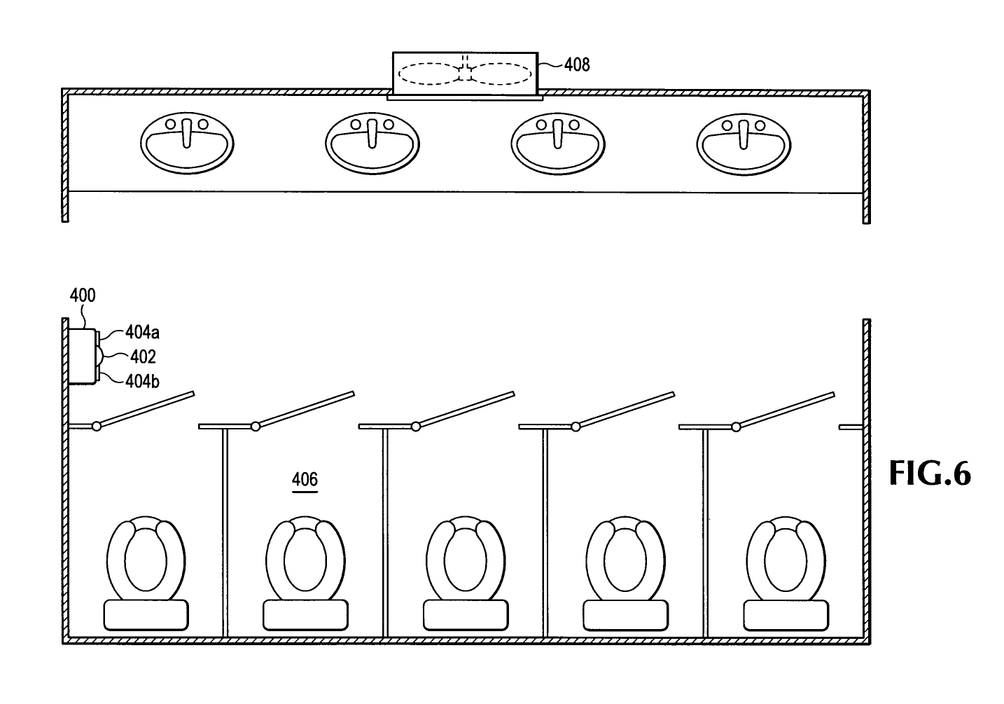

FIG. 5 illustrates another embodiment of an occupancy sensor according to some of the inventive principles of this patent disclosure. The embodiment of FIG. 5 is configured as a wall-switch intended for mounting in a standard electrical wall box. The occupancy sensor 400 includes an image sensor 402 which provides up to a 180 degree field of view from the mounting location within a room as shown in FIG. 6. The occupancy sensor 400 also includes one or more directional or omni-directional audio sensors 404. In case of an omni-directional audio sensor, the occupancy sensor may respond to sounds from anywhere in the room. If directional audio sensors are used, they may be configured to complement the video sensing operation. For example, in a restroom installation as shown in FIG. 6, the image sensor may be configured for 180 degree field of view, but occupants within stalls 406 may be outside of the field of view. One of the audio sensors 404b, which is oriented in the direction of the stalls may be enabled to sense sound from occupants within the stalls, whereas the other audio sensor 404a is disabled so not to react to noise from exhaust fan 408.

In this embodiment, the occupancy sensor includes power switching circuitry to energize or de-energize lighting or other electrical loads for the monitored space in the room in response to the occupancy determination. Connections to the occupancy sensor are through pigtail wire leads 410 which include hot, neutral, switched and ground connections.

Various controls for adjusting the operation of the sensor maybe located anywhere on the device, but in the embodiment of FIG. 5, they are shown on the front of the device to provide easy access. An access door or panel may cover the controls when they are not being adjusted. These controls may be implemented to control any of the operational characteristics of the occupancy sensor as described above.

The embodiments of FIGS. 3 and 5 may enable components from other types of occupancy sensors to be reused and/or repurposed for an occupancy sensor according to some of the inventive principles of this patent disclosure, thereby reducing the time and cost required for design, testing, manufacturing, etc.

The inventive principles of this patent disclosure have been described above with reference to some specific example embodiments, but these embodiments can be modified in arrangement and detail without departing from the inventive concepts. For example, some detailed embodiments have been described in the context of systems in which a first sensor includes an image sensor and a second sensor includes an audio sensor. In other embodiments, however, the second sensor may include a passive or an active ultrasound sensor, a passive infrared (PIR), or any other sensor based on a technology that does not monitor a visual characteristic of the space. In yet other embodiments, the first sensor may include a first type of image sensor, while the second sensor may include a second type of image sensor. Such changes and modifications are considered to fall within the scope of the following claims.

1. A method comprising:
monitoring a space with an image sensor;
monitoring the space with an audio sensor;
determining an occupancy condition of the space in response to information from the image sensor and the audio sensor; and
controlling an electrical load for the space in response to the occupancy condition.

2. The method of claim 1 wherein information from the image sensor is used to determine that the occupancy condition has changed from unoccupied to occupied.

3. The method of claim 2 wherein information from the audio sensor is essentially unused in determining that the occupancy condition has changed from unoccupied to occupied.

4. The method of claim 2 wherein information from the audio sensor is used to determine that the space continues to be occupied.

5. The method of claim 2 wherein information from the image sensor is used to determine that the space continues to be occupied.

6. The method of claim 1 wherein the occupancy condition of the space is determined to be tentatively unoccupied if information from the image sensor and information from the audio sensor both indicate an unoccupied condition for a period of time.

7. The method of claim 6 wherein information from the audio sensor is used to determine the occupancy condition of the space during a tentative unoccupied period.

8. The method of claim 7 wherein the occupancy condition of the space is determined to be confirmed unoccupied if information from the audio sensor indicates an unoccupied condition for a second period of time.

9. A system comprising:
a first sensor to monitor visual images of a space;
a second sensor to monitor the space, wherein the second sensor utilizes a different sensing technology than the first sensor;
a controller coupled to the first sensor and the second sensor to determine an occupancy condition of the space in response to information from the first sensor and the second sensor;
wherein the controller is to control an electrical load for the space in response to the occupancy condition.

10. The system of claim 9 wherein the second sensor is to monitor a non-visual characteristic of the space.

11. The system of claim 10 wherein the second sensor includes an audio sensor.

12. The system of claim 10 wherein the second sensor includes a passive infrared sensor.

13. The system of claim 10 wherein the second sensor includes an ultrasonic sensor.

14. The system of claim 9 wherein the first sensor comprises a video camera.

15. The system of claim 9 wherein the first sensor, the second sensor and the controller are disposed in the same enclosure.

16. The system of claim 9 further comprising at least one illuminator to provide illumination in the space for the first sensor.

17. The system of claim 16 wherein the controller is coupled to the illuminator to selectively control the illuminator.

18. A method comprising:
monitoring a first portion of a space with an image sensor, wherein the space includes a second portion that is outside of a field of view of the image sensor;
monitoring the second portion of the space with an audio sensor;
determining an occupancy condition of the space in response to information from the image sensor and the audio sensor; and
controlling an electrical load for the space in response to the occupancy condition.

19. The method of claim 18 wherein the image sensor is mounted on a ceiling.

20. The method of claim 18 wherein the image sensor is mounted to a wall box.
